(19) United States
(12) Patent Application Publication
(10) Pub. No.: US 2010/0297505 A1
(43) Pub. Date: Nov. 25, 2010

(54) METHOD OF PRODUCING NITRIDED LI-TI COMPOUND OXIDE, NITRIDED LI-TI COMPOUND OXIDE, AND LITHIUM-ION BATTERY

(75) Inventors: Hideki Oki, Susono-shi (JP); Toshihiro Seguchi, Susono-shi (JP)

Correspondence Address: GIFFORD, KRASS, SPRINKLE,ANDERSON & CITKOWSKI, P.C, PO BOX 7021, TROY, MI, 48007-7021, US

(73) Assignee: Toyota Jidosha Kabushiki Kaisha, Toyota-Shi (JP)

(21) Appl. No.: 12/784,926

(22) Filed: May 21, 2010

(30) Foreign Application Priority Data
May 21, 2009 (JP) JP2009-123351
Feb. 16, 2010 (JP) JP2010-031174

(51) Int. Cl. H01M 4/58; H01M 4/88

(52) U.S. Cl. 429/231.95; 252/182.1

(57) ABSTRACT

Provided is a method of producing a nitrided Li—Ti compound oxide, including: preparing a raw material composite that has a raw material containing lithium, titanium, and oxygen and a nitriding agent that is expressed by a following General Formula (1) and is solid or liquid at room temperature (25° C.); and synthesizing the nitrided Li—Ti compound oxide by firing the raw material composite to nitride the raw material.

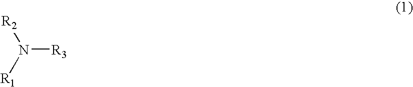

R₁, R₂, and R₃ are independent of each other and are each a functional group having at least one of carbon (C), hydrogen (H), oxygen (O), and nitrogen (N).

### INCORPORATION BY REFERENCE

The disclosure of Japanese Patent Application No. 2009-123351 filed on May 21, 2009 and Japanese Patent Application No. 2010-031174 filed on Feb. 16, 2010 including the specification, drawings and abstract is incorporated herein by reference in its entirety.

### BACKGROUND OF THE INVENTION

1. Field of the Invention

The invention relates to a method of producing a nitrided Li—Ti compound oxide useful as a negative electrode active material, for example, the nitrided compound oxide, and a lithium-ion battery.

2. Description of the Related Art

The lithium-ion battery has a high electromotive force and a high energy density, and has been widely put into practice in the field of information-related equipment and communication equipment. Meanwhile, in the field of automobiles, the development of electric vehicles and hybrid vehicles is an urgent business in terms of the environmental problem and the resource problem and as the power source for these vehicles, lithium-ion batteries are being studied. The lithium-ion battery typically has a positive electrode active material layer containing a positive electrode active material, a negative electrode active material layer containing a negative electrode active material, and an electrolyte layer formed between the positive electrode active material layer and the negative electrode active material layer.

It has been known that Li—Ti compound oxides, typified by Li₄Ti₅O₁₂, are used as a negative electrode active material for a lithium-ion battery. For example, WO/2006/082846 describes that a sintered target made of lithium titanium oxide (Li₄Ti₅O₁₂) is used to form a Li₄Ti₅O₁₂ film by radio frequency magnetron sputtering, in which oxygen is introduced, and the formed film is used as the negative electrode active material. Meanwhile, Japanese Patent Application Publication No. 2008-41402 (IP-A-2008-41402) describes that powder Li₄Ti₅O₁₂ is used as the negative electrode active material.

Meanwhile, a method of nitriding a Li—Ti compound oxide with the use of ammonia is available. Japanese Patent Application Publication No. 2006-32321 (JP-A-2006-32321) describes a method of producing an active material, in which, after heating an oxide that has a resistivity of 1×10⁴ Ωcm or more in a reducing atmosphere, the oxide is reacted with ammonia gas to obtain a nitrided oxide that is expressed by a composition formula of LiₓTiO_{y}N_{z}, where 0≦x≦2, 0.1<y<2.2, 0<z<1.4. Meanwhile, although not a method of producing a negative electrode active material, a method of nitriding an oxide with the use of urea is available. Japanese Patent Application Publication No. 2002-154823 (JP-A-2002-154823) describes a method of producing an inorganic oxynitride having a photocatalytic activity by heating a mixture of an oxide (titanium oxide, for example) that has a particular specific surface area and a nitrogen compound (urea, for example) that is adsorbed by the oxide at room temperature.

Using Li₄Ti₅O₁₂ as the negative electrode active material of a lithium-ion battery is advantageous in being safer than the case where a conventional carbon material is used because it is possible to prevent the occurrence of dendrite of Li metal. This is because the reduction potential (approximately 1.5 V vs Li/Li⁺) of Li₄Ti₅O₁₂ is higher than the reduction potential (approximately 0.2 V vs Li/Li⁺) of carbon material. However, although the safety is higher, when Li₄Ti₅O₁₂ is used, the potential difference between the positive electrode active material and the negative electrode active material is reduced and the battery voltage is therefore reduced as compared to the case where carbon material is used.

### SUMMARY OF THE INVENTION

The invention has been made in consideration of the above problem and an object of the invention is to provide a method of producing a nitrided Li—Ti compound oxide, by which it is possible to obtain a nitrided Li—Ti compound oxide that is low in reduction potential.

A first aspect of the invention is a method of producing a nitrided Li—Ti compound oxide, including: preparing a raw material composite that has a raw material containing lithium, titanium, and oxygen and a nitriding agent that is expressed by a following General Formula (1) and is solid or liquid at room temperature (25° C.); and synthesizing the nitrided Li—Ti compound oxide by firing the raw material composite to nitride the raw material,

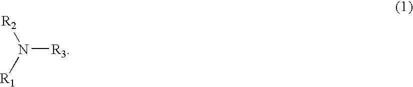

In the General Formula (1), R₁, R₂, and R₃ are independent of each other and are each a functional group having at least one of carbon (C), hydrogen (H), oxygen (O), and nitrogen (N).

According to the first aspect of the invention, the raw material composite containing the nitriding agent that is solid or liquid at room temperature is used and the raw material composite is fired, whereby a nitrided Li—Ti compound oxide that is low in reduction potential is obtained. Thus, when the nitrided Li—Ti compound oxide is used as the negative electrode active material, for example, the potential difference between the positive electrode active material and the negative electrode active material (battery voltage) is increased.

A second aspect of the invention is a nitrided Li—Ti compound oxide containing lithium, titanium, oxygen, and nitrogen, wherein the nitrided Li—Ti compound oxide is crystalline.

According to the second aspect of the invention, a nitrided Li—Ti compound oxide that is low in reduction potential is obtained.

A third aspect of the invention is a nitrided Li—Ti compound oxide containing lithium, titanium, oxygen, and nitrogen, wherein the nitrided Li—Ti compound oxide is expressed by LiₐTi_{b}O_{c}N_{d} (0<a≦5, 3≦b≦7, 11≦c≦14, 0.01≦d≦1).

According to the third aspect of the invention, because the nitrided Li—Ti compound oxide has the above composition, the nitrided Li—Ti compound oxide is low in reduction potential.

A fourth aspect of the invention is a nitrided Li—Ti compound oxide containing lithium, titanium, oxygen, and nitrogen, wherein the nitrogen is present in the inside of the nitrided Li—Ti compound oxide.

According to the fourth aspect of the invention, because the nitrogen is present in the inside of the nitrided Li—Ti compound oxide, the nitrided Li—Ti compound oxide is low in reduction potential.

A fifth aspect of the invention is a lithium-ion battery including: a positive electrode active material layer containing a positive electrode active material; a negative electrode active material layer containing a negative electrode active material; and an electrolyte layer formed between the positive electrode active material layer and the negative electrode active material layer, wherein the negative electrode active material is the above-described nitrided Li—Ti compound oxide.

According to the fifth aspect of the invention, the above-described nitrided Li—Ti compound oxide is used as the negative electrode active material, so that it is possible to obtain a lithium-ion battery whose voltage is high.

The invention has an advantage that a nitrided Li—Ti compound oxide that is low in reduction potential is obtained.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is an explanatory diagram showing an example of a method of producing the nitrided Li—Ti compound oxide of the invention;

FIG. 2 is a schematic sectional diagram showing an example of an electricity generating element of a lithium-ion battery of the invention;

FIG. 3 shows a result of the XPS measurement of the nitrified Li—Ti compound oxides obtained in Examples 2-1 to 2-5;

FIG. 4 shows a result of the XRD measurement of nitrided TiO₂ obtained in Comparative Example 2; and

FIG. 5 shows a result of charging and discharging of a coin battery to be evaluated, in which nitrided TiO₂ obtained in Comparative Example 2 is used.

### DETAILED DESCRIPTION OF EMBODIMENTS

A method of producing a nitrided Li—Ti compound oxide, the nitrided Li—Ti compound oxide, and a lithium-ion battery of the invention will be described in detail below.

### A. Method of Producing Nitrided Li—Ti Compound Oxide

First, a method of producing the nitrided Li—Ti compound oxide of the invention will be described. The method of producing the nitrided Li—Ti compound oxide of the invention includes: a preparing step of preparing a raw material composite that contains a raw material containing lithium (Li), titanium (Ti), and oxygen (O) and a nitriding agent that is expressed by the above General Formula (I) and is solid or liquid at room temperature (25° C.); and a synthesizing step of synthesizing a nitrided Li—Ti compound oxide by firing the raw material composite to nitride the raw material.

According to the invention, the raw material composite containing the nitriding agent that is solid or liquid at room temperature is used and the raw material composite is fired, so that it is possible to obtain a nitrided Li—Ti compound oxide that is low in reduction potential. Thus, when a nitrided Li—Ti compound oxide is used as a negative electrode active material, for example, the potential difference between the negative electrode active material and a positive electrode active material (battery voltage) is increased. In addition, by nitriding the raw material, it is possible to improve the Li ion conductivity and the electron conductivity. When the Li ion conductivity is improved, a high-power lithium-ion battery is obtained. When the electron conductivfty is improved, the amount of conducting agent used is relatively reduced and the capacity of the battery is increased.

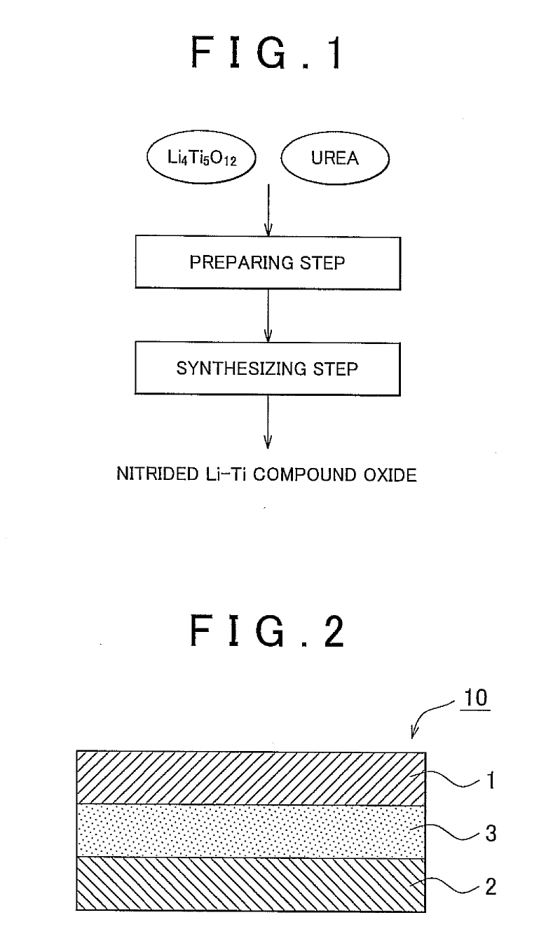

FIG. 1 is an explanatory diagram showing an example of a method of producing the nitrided Li—Ti compound oxide of the invention. In FIG. 1, lithium titanate (Li₄Ti₅O₁₂ is prepared as the raw material and urea is prepared as the nitriding agent. Then, these materials are mixed to prepare the raw material composite (preparing step). Then, the obtained raw material composite is fired at 500° C. in a vacuum, for example, to nitride the raw material, whereby the nitrided Li—Ti compound oxide is synthesized (synthesizing step). Each of the steps of a method of producing the nitrided Li—Ti compound oxide of the invention will be hereinafter described.

### 1. Preparing Step

The preparing step of the invention is a step of preparing the raw-material composite that contains a raw material containing Li, Ti, and O, and a nitriding agent that is expressed by the above General Formula (1) and is solid or liquid at room temperature (25° C.).

### (1) Raw Material

In the invention, the raw material contains Li, Ti, and O. The raw material may be the Li—Ti compound oxide (raw material compound) or may be a mixture of a plurality of compounds (raw material mixture), from which the Li—Ti compound oxide is synthesized, The following description will be given for each of these cases.

### (i) When Raw Material is Li—Ti Compound Oxide

In this case, the raw material is not particularly limited as long as the raw material is a compound (Li—Ti compound oxide) that contains all of Li, Ti, and O. Examples of such a Li—Ti compound oxide include one having a spinel structure and one having a ramsdellite structure.

Specific examples of Li—Ti compound oxide of the invention include Li_{1.33}Ti_{1.66}O₄, Li₄TiO₄, Li₂TiO₃, Li₂Ti₄O₉, Li₂Ti₃O₇, Li_{0.8}Ti_{2.2}O₄, Li₂Ti₃O₇, Li₂Ti₆O₁₃, Li_{0.5}TiO₂, Li₂Ti₂O₄, Li₃Ti₃O₇, Li₃Ti₃O₇, LiTi₂O₄, LiTiO₂, LiTi₂O₄, and Li₄Ti₅O₁₂. Note that the Li—Ti compound oxide may be a compound that is close to these oxides in its composition.

In the invention, it is preferable that the Li—Ti compound oxide be Li₄Ti₅O₁₂ or a compound that is close to this in its composition. Note that Li₄Ti₅O₁₂ is a Li—Ti compound oxide with a spinel structure. In the invention, it is preferable that the Li—Ti compound oxide be a compound that is expressed by the following General Formula (A-1).

LiₐTi_{b}O_{c}(0<a≦5,3≦b≦7,10≦c≦14) General Formula (A-1)

In General Formula (A-1), b preferably satisfies the relation, 4≦b≦6, and more preferably satisfies the relation, 4.5≦b≦5.5. Meanwhile, c preferably satisfies the relation, 11≦c≦13, and more preferably satisfies the relation, 11.5≦c≦12.5.

Although the Li—Ti compound oxide may be particulate (powder) or film, the Li—Ti compound oxide is preferably particulate. This is because the particulate Li—Ti compound oxide does not suffer the occurrence of a detachment, a crack, etc. unlike a film and is therefore excellent in durability, The average particle size of the particulate Li—Ti compound oxide is equal to or larger than 100 nm, for example, and preferably equal to or larger than 2 μm, and more preferably equal to or larger than 4 μm. Meanwhile, the average particle size is equal to or smaller than 100 μm, for example, and preferably equal to or smaller than 20 μm. The average particle size can be determined by a laser diffraction particle size distribution analyzer.

The specific surface area of the Li—Ti compound oxide is equal to or larger than 0.1 m²/g, for example, and preferably equal to or larger than 0.5 m²/g. Meanwhile, the specific surface area of the Li—Ti compound oxide is equal to or smaller than 300 m²/g, for example, and preferably equal to or smaller than 100 m²/g. The specific surface area can be determined by the Brunauer-Emmett-Teller (BET) method (gas adsorption method).

(ii) When Raw Material is Mixture of Multiple Compounds, from which Li—Ti Compound Oxide is Synthesized

As described above, the raw material in the invention may be a mixture of a plurality of compounds (raw material mixture), from which the Li—Ti compound oxide is synthesized. In this case, there is an advantage that the composition of the target nitrided Li—Ti compound oxide is easily adjusted.

Examples of such a raw material mixture include a mixture of titanium oxide (TiO₂) and the chemical compound containing lithium. Examples of the chemical compound containing lithium include Li₂CO₃, Li₂O, LiNO₂, LiNO₃, LiCl, CH₃COOLi, Li₂C₂O₄, LiOH, LiH, and Li₃P. The chemical compound containing lithium is preferably a chemical compound, in which the components other than lithium are vaporized by firing. It is preferable that the amount of addition of each of the chemical compounds in the raw material mixture be selected according to the composition of the target nitrided Li—Ti compound oxide.

### (2) Nitriding Agent

Next, the nitriding agent used in the invention will be described. The nitriding agent used in the invention is expressed by the following General Formula (1) and is solid or liquid at room temperature (25° C.).

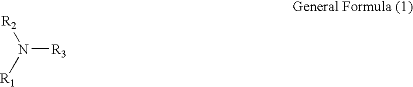

In the above General Formula (1), R₁, R₂, and R₃ are independent of each other and are each a functional group having at least one of carbon (C), hydrogen (1-1), oxygen (O), and nitrogen (N). In the General Formula (1), all of R₁, R₂, and R₃ may be either the same or different from each other. Alternatively, two of R₁, R₂, and R₃ may be the same and different from the other. It is preferable that at least one of R₁, R₂, and R₃ have carbon (C).

The nitriding agent used in the invention is solid or liquid at room temperature (25° C.). When the nitriding agent is solid or liquid, a raw material composite is prepared, in which the nitriding agent and the raw material are in good physical contact with each other, so that the efficiency in nitriding the raw material composite is improved. Note that when a gas, such as ammonia gas, is used as the nitriding agent, nitriding reaction is hard to occur and the ammonia gas is highly corrosive, which can make the facility cost high.

Examples of the nitriding agent used in the invention include urea, methylamine, ethylamine, diethylamine, triethylamine, aminoethane, aniline, nicotine, and cyclohexylamine. Among others, urea is preferable. This is because urea is less adverse to the composition of the target nitrided Li—Ti compound oxide. Note that urea is a chemical compound that is expressed by the General Formula (1), in which R₁ and R₂ are H and R₃ is —CONH₂.

It is preferable that the amount of nitriding agent added be selected according to the composition of the target nitrided Li—Ti compound oxide. When the proportion of the amount of Li in the raw material is 100 molar parts, it is preferable that the proportion of the amount of nitrogen (N) in the nitriding agent be within a range of 10 molar parts to 100 molar parts, for example, and it is more preferable that the proportion be within a range of 30 molar parts to 60 molar parts. Note that in the invention, it is important that the raw material and the nitriding agent are in sufficient contact with each other before firing. When the proportion of the amount of nitriding agent is too high, the part of the nitriding agent that is not in contact with the raw material is not sufficiently nitrided, which can result in the degradation of the efficiency in nitriding as a whole.

### (3) Preparation of Raw Material Composite

The raw material composite used in the invention contains the above-described raw material and the nitriding agent. An example of the method of preparing a raw material composite is a method of mixing a raw material and a nitriding agent. Although the method of mixing the raw material and the nitriding agent is not particularly limited, the more homogeneously the raw material and the nitriding agent are mixed, the more preferable. In particular, in the invention, it is preferable that the raw material and the nitriding agent be mixed by a mechanical milling method (ball milling method, for example). When a mechanical milling method is used, it is possible to perform both pulverization of the raw material and mixing simultaneously and increase the contact area of the raw material ingredients.

The mechanical milling method according to the invention may be either a mechanical milling method that involves a synthesizing reaction or a mechanical milling method that does not involve any synthesizing reaction. The synthesizing reaction herein means a reaction in which a raw material compound is synthesized. Thus, the mechanical milling method that involves a synthesizing reaction can be used when the raw material is a raw material mixture as described above. On the other hand, the mechanical milling method that does not involve any synthesizing reaction can be used when the raw material is a raw material compound (Li—Ti compound oxide) as described above. In this way, homogeneity of mixing of the raw material compound and the nitriding agent is improved. When the mixing is performed by a ball milling method, the rotation speed is within a range of 100 rpm to 11000 rpm, for example, and it is preferable that the rotation speed be within a range of 500 rpm to 5000 rpm. The processing time is not particularly limited and it is preferable that the processing time be set appropriately so as to be able to obtain a desired raw material composite. In the invention, the raw material and the nitriding agent may be merely mixed with the use of a common stirring method.

### 2. Synthesizing Step

Next, the synthesizing step of the invention will be described. The synthesizing step of the invention is a step of synthesizing a nitrided Li—Ti compound oxide by firing the raw material composite to nitride the raw material.

The firing temperature in the invention is not particularly limited as long as it is possible to obtain a desired nitrided Li—Ti compound oxide. It is preferable that the firing temperature be equal to or higher than the temperature, at or above which the nitriding agent is decomposed or melted. This is because it becomes easy to obtain a nitrided Li—Ti compound oxide in which nitrogen is chemically bonded. The firing temperature is preferably selected according to the kind of nitriding agent used. The firing temperature is equal to or higher than 100° C., for example, and preferably equal to or higher than 300° C. When the firing temperature is too low, there is a fear that nitriding reaction does not sufficiently progress and the nitrided Li—Ti compound oxide cannot be obtained. Meanwhile, the firing temperature is equal to or lower than 800′C, for example. The firing temperature is preferably equal to or lower than 700° C., and more preferably equal to or lower than 600° C., and still more preferably equal to or lower than 550° C. When the firing temperature is too high, there is a fear that nitrogen is eliminated from the nitrided Li—Ti compound oxide. The firing time is equal to or longer than 10 minutes, for example, and preferably equal to or longer than 30 minutes. Meanwhile, the firing time is equal to or shorter than 7 hours, for example, and preferably equal to or shorter than 5 hours.

The atmosphere during firing is not particularly limited. Examples of the atmosphere include: an air atmosphere; an inert gas atmosphere, such as a nitrogen atmosphere or an argon atmosphere; a reducing atmosphere, such as an ammonia atmosphere or a hydrogen atmosphere; and vacuum. Among others, the inert gas atmosphere, the reducing atmosphere, and the vacuum are preferable and in particular, the reducing atmosphere is preferable. This is because it is possible to prevent the nitrided Li—Ti compound oxide from being degraded due to oxidation. Examples of the method of firing the raw material composite include a method using a firing furnace. In the invention, it is preferable that after a nitrided Li—Ti compound oxide is synthesized, firing for removing the remaining urea be performed.

### 3. Other

The nitrided Li—Ti compound oxide obtained in the invention is useful for an electrode active material, for example, and it is particularly preferable that the nitrided Li—Ti compound oxide be used as a negative electrode active material. With the invention, a nitrified Li—Ti compound oxide (negative electrode active material) that is low in reduction potential is obtained and therefore, it is possible to increase the voltage of a battery. Thus, the invention provides a method of manufacturing lithium-ion batteries, which is characterized by including a step of performing the preparing step and the synthesizing step to obtain a negative electrode active material and a step of forming a negative electrode active material layer with the use of the negative electrode active material. The invention also provides a negative electrode active material characterized by being obtained by the above producing method.

### B. Nitrided Li—Ti Compound Oxide

Next, a nitrided Li—Ti compound oxide of the invention will be described. The nitrided Li—Ti compound oxide of the invention is obtained by the method described in the above section “A. Method of Producing Nitrided Li—Ti Compound Oxide,” for example. It is preferable that the nitrided Li—Ti compound oxide of the invention be such that part of oxygen atoms (O) are replaced by nitrogen atoms (N). The nitrided Li—Ti compound oxides of the invention are broadly classified into following first to third embodiments. Each of the embodiments will be described below.

### First Embodiment

A first embodiment of the nitrided Li—Ti compound oxide of the invention is a nitrided Li—Ti compound oxide that has Li, Ti, O, and N and is characterized by being crystalline. The fact that the nitrided Li—Ti compound oxide is crystalline can be confirmed by X-ray diffraction (XRD).

The first embodiment provides a nitrided Li—Ti compound oxide that is low in reduction potential. In addition, because the nitrided Li—Ti compound oxide is crystalline, there are advantages that reversibility in insertion and extraction of Li ions is higher and that the battery voltage is more highly stable, as compared to the case where the nitrided Li—Ti compound oxide is amorphous. The above-cited JP-A-2006-32321 describes that the active material is amorphous (claim 2 and FIG. 3 thereof, for example). However, there is no description that the active material is crystalline. Even when the Li—Ti compound oxide (Li₄Ti₅O₁₂, for example) is nitrided under conditions described in JP-A-2006-32321 (conditions, in which ammonia is used), the nitrided Li—Ti compound oxide that is crystalline cannot be obtained.

The composition of the nitrided Li—Ti compound oxide of the first embodiment is not particularly limited. However, it is preferable that the composition be similar to the composition of the nitrided Li—Ti compound oxide obtained by “A. Method of Producing Nitrified Li—Ti Compound Oxide” described above, for example. The nitrided Li—Ti compound oxide of the first embodiment may further have at least one of the features of second and third embodiments described below. Details will be described in the description of each of the embodiments.

The nitrided Li—Ti compound oxide of the first embodiment may be either particulate (powder) or film. However, the Li—Ti compound oxide is preferably particulate. This is because the particulate Li—Ti compound oxide does not suffer the occurrence of a detachment, a crack etc. unlike a film and is therefore excellent in durability. The average particle size of the particulate, nitrided Li—Ti compound oxide is equal to or larger than 100 nm, for example, and preferably equal to or larger than 2 μm, and more preferably equal to or larger than 4 μm. Meanwhile, the average particle size is equal to or smaller than 100 nm, for example, and preferably equal to or smaller than 20 μm. The average particle size can be determined by a laser diffraction particle size distribution analyzer.

The specific surface area of the nitrided Li—Ti compound oxide of the first embodiment is equal to or larger than 0.1 m²/g, for example, and preferably equal to or larger than 0.5 m²/g. Meanwhile, the specific surface area of the nitrided Li—Ti compound oxide is equal to or smaller than 300 m²/g, for example, and preferably equal to or smaller than 100 m²/g. The specific surface area can be determined by the Brunauer-Emmett-Teller (BET) method (gas adsorption method). When a film that is formed by sputtering or vapor deposition commonly used is scraped, there is a possibility that a particulate nitrided Li—Ti compound oxide similar to the nitrided Li—Ti compound oxide described above is obtained. However, such particles are formed from a film that has little unevenness and therefore, the specific surface area of such particles is small. On the other hand, the nitrided Li—Ti compound oxide obtained by the method described in the above section, “A. Method of Producing Nitrided Li—Ti Compound Oxide,” has unevenness in the surface of the particles and therefore, the specific surface area thereof is large.

It is preferable that the nitrided Li—Ti compound oxide of the first embodiment be such that nitrogen atom(s) (N) are not merely adsorbed by the Li—Ti compound oxide but incorporated into the composition of the nitrided Li—Ti compound oxide. In the first embodiment, it is preferable that the nitrided Li—Ti compound oxide be such that part of oxygen atoms (O) are replaced by nitrogen atoms (N) as described above.

It is preferable that the nitrided Li—Ti compound oxide of the first embodiment be lower in reduction potential than the Li—Ti compound oxide before nitriding. This is because it is possible to increase the battery voltage when the nitrided Li—Ti compound oxide is used as a negative electrode active material. Specifically, the reduction potential is preferably at least 0.5 V (vs. Li/Li⁺) lower than, and more preferably at least 0.9 V (vs. Li/Li⁺) lower than that of the Li—Ti compound oxide before nitriding.

The nitrided Li—Ti compound oxide of the first embodiment is useful as an electrode active material, for example, and it is preferable that the nitrided Li—Ti compound oxide be used as a negative electrode active material. This is because the reduction potential is low and it is therefore possible to increase the battery voltage. It is preferable that the nitrided Li—Ti compound oxide of the first embodiment be one that is obtained by the method described in the above section, “A. Method of Producing Nitrided Li—Ti Compound Oxide.”

### Second Embodiment

Next, a second embodiment of the nitrided Li—Ti compound oxide of the invention will be described. The nitrided Li—Ti compound oxide of the second embodiment is a nitrided Li—Ti compound oxide that has Li, Ti, O, and N and is characterized by being a compound that is expressed by LiₐTi_{b}O_{c}N_{d} (0<a≦5, 3≦b≦7, 11≦c≦14, 0.01≦d≦1). This general formula is in some cases referred to as the General Formula (B-1),

According to the second embodiment, because the nitrided Li—Ti compound oxide has the above composition, a nitrided Li—Ti compound oxide that is low in reduction potential is obtained. In JP-A-2006-32321 cited above, an active material is disclosed that is expressed by the general formula: LiₓTiO_{y}N_{z} (wherein 0≦x≦2, 0.1<y,2.2, 0<z<1.4) (claim 3). When the numerical subscript of Ti is 5, the above general formula becomes Li_{Z}Ti₅O_{Y}N_{Z} (where 0≦X≦10, 0.5<Y<11, 0<Z<7). The “O” part does not overlap between the general formula of the second embodiment and the general formula of the JP-A-2006-32321. Even when LiₐTiᵥO_{c} (Li₄Ti₅O₁₂, for example) is nitrided under conditions described in JP-A-2006-32321 (conditions, in which ammonia is used), the nitrided Li—Ti compound oxide expressed by the General Formula (B-1) described above cannot be obtained. When ammonia is used, sufficient nitriding is not performed and therefore, it is difficult to achieve the above composition with respect to nitrogen.

In the General Formula (B-1), b preferably satisfies 4≦b≦6, and more preferably satisfies 4.5≦b≦5.5; c preferably satisfies 11≦c≦13, and more preferably satisfies 11.5≦c≦12.5; d preferably satisfies 0.055d, and more preferably satisfies 0.15≦d.

The composition of the nitrided Li—Ti compound oxide of the second embodiment is as described above. The nitrided Li—Ti compound oxide of the second embodiment may be either amorphous or crystalline. The nitrided Li—Ti compound oxide of the second embodiment may further have at least one of the features of the first embodiment described above and a third embodiment described below. The shape, physical properties, etc. of the nitrided Li—Ti compound oxide are similar to those of the first embodiment described above and the description thereof is therefore omitted.

### Third Embodiment

Next, a third embodiment of the nitrided Li—Ti compound oxide of the invention will be described. The nitrified Li—Ti compound oxide of the third embodiment is a nitrided Li—Ti compound oxide that has Li, Ti, O, and N and is characterized in that nitrogen is present in the inside of the nitrided Li—Ti compound oxide. The presence of nitrogen in the inside of a nitrided Li—Ti compound oxide can be confirmed based on the N1s peak (the peak occurring between 395 eV and 398 eV) of the XPS measurement.

According to the third embodiment, nitrogen is present in the inside of the nitrided Li—Ti compound oxide, so that it is possible to obtain a nitrided Li—Ti compound oxide that is low in reduction potential. In JP-A-2006-32321 cited above, there is no description that nitrogen is present in the inside of the nitrided Li—Ti compound oxide. Even when the Li—Ti compound oxide (Li₄Ti₅O₁₂, for example) is nitrided under conditions described in JP-A-2006-32321 (conditions, in which ammonia is used), only the surface of the Li—Ti compound oxide is nitrided and nitrogen is not present in the inside of the nitrided Li—Ti compound oxide.

The “inside” in the invention means the position at 20 nm or deeper from the surface of the nitrided Li—Ti compound oxide.

The composition of the nitrided Li—Ti compound oxide of the third embodiment is not particularly limited. However, it is preferable that the composition is similar to that of the nitrided Li—Ti compound oxide that is obtained by “A. Method of Producing Nitrided Li—Ti Compound Oxide” described above. The nitrided Li—Ti compound oxide of the third embodiment may be either amorphous or crystalline. The nitrided Li—Ti compound oxide of the third embodiment may further have at least one of the features of the first and second embodiments described above. The shape, physical properties, etc. of the nitrided Li—Ti compound oxide are similar to those of the first embodiment described above and the description thereof is therefore omitted.

### C. Lithium-Ion Battery

Next, a lithium-ion battery of the invention will be described. The lithium-ion battery of the invention is a lithium-ion battery that has a positive electrode active material layer containing a positive electrode active material; a negative electrode active material layer containing a negative electrode active material; and an electrolyte layer formed between the positive electrode active material layer and the negative electrode active material layer, the lithium-ion battery being characterized in that the negative electrode active material is a nitrided Li—Ti compound oxide described above.

According to the invention, a lithium-ion battery is obtained, of which the battery voltage is high, by using a nitrided Li—Ti compound oxide described above as the negative electrode active material. In addition, when a nitrided Li—Ti compound oxide described above is used, it is possible to improve the Li ion conductivity and the electron conductivity. In addition, because the nitrided Li—Ti compound oxide is excellent in cycle characteristics, it is possible to elongate the life of a lithium ion battery. In addition, the nitrided Li—Ti compound oxide has an advantage that the nitrided Li—Ti compound oxide is excellent in stability at high temperatures and low temperatures.

FIG. 2 is a schematic sectional diagram showing an example of an electricity generating element of a lithium-ion battery of the invention. The electricity generating element 10 shown in FIG. 2 includes: a positive electrode active material layer 1 containing a positive electrode active material; a negative electrode active material layer 2 containing a negative electrode active material; and an electrolyte layer 3 formed between the positive electrode active material layer I and the negative electrode active material layer 2. In addition, the invention is largely characterized in that a nitrided Li—Ti compound oxide described above is used as the negative electrode active material contained in the negative electrode active material layer 2. The electrolyte layer 3 may be any one of a liquid electrolyte layer, a gel electrolyte layer, and a solid electrolyte layer, as described later. Each of the constituent elements of the lithium-ion battery of the invention will be described below.

### 1. Negative Electrode Active Material Layer

First, the negative electrode active material layer of the invention will be described. The negative electrode active material layer of the invention is a layer containing at least a nitrided Li—Ti compound oxide described above as the negative electrode active material and may contain at least one of an electrically conducting material, a binder, and a solid electrolyte material, as needed. In particular, when the lithium-ion battery of the invention has a liquid electrolyte layer, it is preferable that the negative electrode active material layer further contain a binder. This is because falling off of the negative electrode active material is effectively suppressed. In addition, when the lithium-ion battery of the invention has a solid electrolyte layer, it is preferable that the negative electrode active material layer further contain a solid electrolyte material. This is because it is possible to improve the Li ion conductivity in the negative electrode active material layer.

Regarding the nitrided Li—Ti compound oxide used as the negative electrode active material, description is similar to that given in the above section, “B. Nitrided Li—Ti Compound Oxide,” and the description is therefore omitted. The electrically conducting material is not particularly limited as long as it has a desired electrical conductivity and examples thereof include an electrically conducting material made of a carbon material. Specifically, such examples include acetylene black, carbon black, coke, carbon fibers, and graphite. It is more preferable that the electrically conducting material be carbon fibers, the average diameter of which is equal to or smaller than 1 μm, graphite, and coke, the heat treatment temperature of which is 800° C. to 2000° C. and the average particle size of which is equal to or smaller than 10 μm. The BET specific surface area of the electrically conducting material measured by causing N₂ to be adsorbed is preferably equal to or larger than 10 m²/g.

It is preferable that the binder be chemically and electrically stable and specifically, examples of the binder include a fluorine-based binder, such as polyvinylidene fluoride (PVDF) or polytetrafluoroethylene (PTFE), and a rubber binder, such as styrene-butadiene rubber. The solid electrolyte material is not particularly limited as long as the solid electrolyte material has the Li ion conductivity. Examples of the solid electrolyte material include oxide-based solid electrolyte material and sulfide-based solid electrolyte material, and the sulfide-based solid electrolyte material is preferable. This is because the Li ion conductivity is high and it is possible to obtain a high-power battery. The solid electrolyte material will be described in detail in the section, “3. Electrolyte Layer,” below.

In terms of the capacity, the more the amount of negative electrode active material contained in the negative electrode active material layer is, the more preferable. The amount of negative electrode active material is within a range of 60 percent by weight to 99 percent by weight, for example, and preferably within a range of 70 percent by weight to 95 percent by weight. The less the amount of electrically conducting material contained is, the more preferable, as long as a desired electron conductivity is obtained. The amount of electrically conducting material is preferably within a range of 1 percent by weight to 30 percent by weight, for example. The less the amount of binder contained is, the more preferable, as long as it is possible to stably fix the negative electrode active material etc. The amount of binder is preferably within a range of 1 percent by weight to 30 percent by weight, for example. The less the amount of solid electrolyte material contained is, the more preferable, as long as it is possible to secure a desired electron conductivity. The amount of solid electrolyte material is preferably within a range of 1 percent by weight to 40 percent by weight, for example.

The thickness of the negative electrode active material layer significantly varies depending on the configuration of a lithium-ion battery, and is preferably within a range of 0.1 μm to 1000 μm, for example.

### 2. Positive Electrode Active Material Layer

Next, the positive electrode active material of the invention will be described. The positive electrode active material of the invention is a layer containing at least a positive electrode active material. The positive electrode active material layer may contain at least one of an electrically conducting material, a binder, and a solid electrolyte material, as needed. In particular, when the lithium-ion battery of the invention has a liquid electrolyte layer, it is preferable that the positive electrode active material layer further contain a binder. This is because falling off of the positive electrode active material is effectively suppressed. In addition, when the lithium-ion battery of the invention has a solid electrolyte layer, it is preferable that the positive electrode active material layer further contain a solid electrolyte material. This is because it is possible to improve the Li ion conductivity in the positive electrode active material layer.

Examples of the positive electrode active material include layered positive electrode active material, spinel-type positive electrode active material, and olivine-type positive electrode active material. Examples of the layered positive electrode active material include LiCoO₂, LiNiO₂, LiCO_{1/3}Ni_{1/3}Mn_{1/3}O₂, LiVO₂, and LiCrO₂. Examples of the spinel-type positive electrode active material include LiMn₂O₄, LiCoMnO₄, Li₂NiMn₃O₈, and LiNi_{0.5}Mn_{1.5}O₄. Examples of the olivine-type positive electrode active material include LiCoPO₄, LiMnPO₄, and LiFePO₄.

The shape of the positive electrode active material is preferably particulate. The average particle size of the positive electrode active material is within a range of 1 nm to 100 μm, for example, and preferably within a range of 10 nm to 30 μm. The specific surface area of the positive electrode active material is preferably within a range of 0.1 m²/g to 10 m²/g, for example. The electrically conducting material, the binder, and the solid electrolyte material that are used for the positive electrode active material layer are similar to those used for the negative electrode active material layer described above and the description thereof is omitted.

In terms of the capacity, the more the amount of positive electrode active material contained in the positive electrode active material layer is, the more preferable. The amount of positive electrode active material is within a range of 60 percent by weight to 99 percent by weight, for example, and preferably within a range of 70 percent by weight to 95 percent by weight. The less the amount of electrically conducting material contained is, the more preferable, as long as a desired electron conductivity is obtained. The amount of electrically conducting material is preferably within a range of 1 percent by weight to 30 percent by weight, for example. The less the amount of binder contained is, the more preferable, as long as it is possible to stably fix the positive electrode active material etc. The amount of binder is preferably within a range of 1 percent by weight to 30 percent by weight, for example. The less the amount of solid electrolyte material contained is, the more preferable, as long as it is possible to secure a desired electron conductivity. The amount of solid electrolyte material is preferably within a range of 1 percent by weight to 40 percent by weight, for example.

The thickness of the positive electrode active material layer significantly varies depending on the configuration of a lithium-ion battery, and is preferably within a range of 0.1 μm to 1000 μm, for example.

### 3. Electrolyte Layer

Next, the electrolyte layer of the invention will be described. The electrolyte layer of the invention is a layer formed between the positive electrode active material layer and the negative electrode active material layer. The Li ion conduction between the positive electrode active material and the negative electrode active material is performed through the electrolyte contained in the electrolyte layer. The form of the electrolyte layer is not particularly limited. Examples of the form of the electrolyte layer include a liquid electrolyte layer, a gel electrolyte layer, and a solid electrolyte layer.

The liquid electrolyte layer is typically a layer formed with the use of a nonaqueous electrolyte solution. The nonaqueous electrolyte solution of a lithium-ion battery typically contains a lithium salt and a nonaqueous solvent. Examples of the lithium salt include inorganic lithium salts, such as LiPF₆, LiBF₄, LiCIO₄, or LiAsF₆, and an organic lithium salts, such as LiCF₃SO₃, LiN(CF₃SO₂)₂, or LiN(C₂F₅SO₂)₂, LiC(CF₃SO₂)₃. Examples of the nonaqueous solvent include ethylene carbonate (EC), propylene carbonate (PC), dimethyl carbonate (DMC), diethyl carbonate (DEC), ethyl methyl carbonate (EMC), butylene carbonate, γ-butyrolactone, sulfolane, acetonitrile, 1,2-dimethoxyethane, 1,3-dimethoxypropane, diethyl ether, tetrahydrofuran, 2-methyltetrahydrofuran, and a mixture of these compounds. The concentration of the lithium salt in the nonaqueous electrolyte solution is within a range of 05 mol/L to 3 mol/L, for example. In the invention, a low-volatile liquid, such as an ionic liquid, may be used as the nonaqueous electrolyte solution.

The gel electrolyte layer can be obtained by adding a polymer to the nonaqueous electrolyte solution for gelation, for example. Specifically, gelation can be performed by adding a polymer, such as polyethylene oxide (PEO), polyacrylonitrile (PAN), or polymethylmethacrylate (PMMA) to the above nonaqueous electrolyte solution.

The solid electrolyte layer is formed with the use of a solid electrolyte material. Examples of the solid electrolyte material include oxide-based solid electrolyte material and sulfide-based solid electrolyte material, and the sulfide-based solid electrolyte material is particularly preferable. This is because the Li ion conductivity is high and it is possible to obtain a high-power battery. The sulfide-based solid electrolyte material is not particularly limited as long as the sulfide-based solid electrolyte material contains Li and S and has Li ion conductivity. Examples of the sulfide-based solid electrolyte material include one that contains Li, S and a third component A. The third component A may be at least one selected from the group consisting of P, Ge, B, Si, I, Al, Ga, and As. In particular, in the invention, it is preferable that the sulfide-based solid electrolyte material be a compound obtained with the use of Li₂S and a sulfide (MS) other than Li₂S. Specifically, examples of the sulfide-based solid electrolyte material include Li₂S—P₂S—₅ compound, Li₂S—SiS₂ compound, and Li₂S—GeS₂ compound. Among others, Li₂S—P₂S₅ is preferable. This is because the Li ion conductivity is high. When it is assumed that the molar ratio between Li₂S and the sulfide (MS) satisfies xLi₂S-(100-x)MS, it is preferable that x satisfy the relation, 50≦x≦95, and it is more preferable that x satisfy the relation, 60≦x≦85. The Li₂S—P₂S₅ compound means a sulfide-based solid electrolyte material obtained with the use of Li₂S and P₂S₅. The same applies to the other compounds. For example, by performing a mechanical milling method or a melt-quenching method using Li₂S and P₂S₅, an amorphous Li₂S—P₂S₅ compound is obtained.

The sulfide-based solid electrolyte material may be either amorphous or crystalline. A crystalline, sulfide-based solid electrolyte material is obtained by firing an amorphous sulfide-based solid electrolyte material, for example. It is preferable that the sulfide-based solid electrolyte material have bridging sulfur atoms. This is because the Li ion conductivity of such a sulfide-based solid electrolyte material is high. In particular, in the invention, it is preferable that the sulfide-based solid electrolyte material be Li₇P₃S₁₁. This is because the Li ion conductivity is high, The average particle size of the solid electrolyte material is within a range of 1 nm to 100 μm, for example, and preferably within a range of 10 nm to 30 μm,

The thickness of the electrolyte layer significantly varies depending on the configuration of a lithium-ion battery. The thickness is within a range of 0.1 μm to 1000 μm, for example, and preferably within a range of 0.1 μm to 300 μm.

### 4. Other Elements

The lithium-ion battery of the invention has at least the negative electrode active material layer, the electrolyte layer, and the positive electrode active material layer. Typically, the lithium-ion battery has a positive electrode current collector for collecting electric currents flowing through the positive electrode active material layers and a negative electrode current collector far collecting electric currents flowing through the negative electrode active material layers. Examples of the material for the positive electrode current collector include SUS, aluminum, nickel, iron, titanium, and carbon. Among others, SUS is preferable. Examples of the material for the negative electrode current collector include SUS, copper, nickel, and carbon. Among others, SUS is preferable. It is preferable that the thickness, shape, etc. of the positive electrode current collector and the negative electrode current collector be selected according to the application etc. of the lithium-ion battery.

The lithium-ion battery of the invention may have a separator between the positive electrode active material layer and the negative electrode active material layer. This is because a safer lithium-ion battery is obtained. Examples of the material for the separator include porous films made of polyethylene, polypropylene, cellulose, polyvinylidene fluoride, or the like, and nonwoven fabric, such as resin nonwoven fabric or glass-fiber nonwoven fabric. A commonly used battery case for a lithium-ion battery can be used as the battery case used in the invention. Examples of the battery case include a battery case made of SUS. When the lithium-ion battery of the invention is an all-solid-state battery, electricity generating elements may be formed inside the insulation ring.

### 5. Lithium-Ion Battery

The lithium-ion battery of the invention is not particularly limited as long as the lithium-ion battery has the positive electrode active material layer, the negative electrode active material layer, and the electrolyte layer, which have been described above. In particular, preferable configurations of the lithium-ion battery of the invention are as follows: the lithium-ion battery of the invention has a negative electrode including the negative electrode active material layer and the negative electrode current collector carrying the negative electrode active material layer; the negative electrode active material layer further contains an electrically conducting material made of carbon material; the electrolyte layer is a liquid electrolyte layer that contains a sultone having unsaturated hydrocarbon radical; the diameter distribution of the pores in the negative electrode measured by the mercury intrusion method has a first peak having a mode diameter equal to or larger than 0.01 μm and equal to or smaller than 0.2 μm and a second peak having a mode diameter equal to or larger than 0.003 μm and equal to or smaller than 0.02 μm; and the volume of the pores, of which the diameter measured by the mercury intrusion method is between 0.01 μm and 0.2 μm inclusive, and the volume of the pores, of which the diameter measured by the mercury intrusion method is between 0.003 μm and 0.02 μm inclusive, are between 0.05 mL and 0.5 mL inclusive and between 0.0001 mL and 0.02 mL inclusive, respectively, per 1 g of the negative electrode (with the weight of the negative electrode current collector excluded). This is because the generation of gas during storage under high-temperature conditions is suppressed and it is therefore possible to obtain a lithium-ion battery that is excellent in high current operation and cycle characteristics. In particular, because the lithium-ion battery according to the invention is excellent in the high current operation, it is possible to shorten the time required to charge the battery to 90% of the capacity.

Specifically, when a sultone having an unsaturated hydrocarbon radical is used in the lithium-ion battery including a negative electrode active material layer containing a nitrided Li—Ti compound oxide, it is conceivable that a coating film that is thick and suppresses the decomposition of the liquid electrolyte, is formed on the carbon material that is the (negative electrode) electrically conducting material, and that a film that is thin, stable, and low in resistance, is formed on the surface of the negative electrode active material. Thus, it is conceivable that films that have their respective properties different from each other are selectively formed on the electrically conducting material and the negative electrode active material, respectively, and that it is possible to suppress the generation of gas during storage under high-temperature conditions.

The mode diameter of the first peak of the diameter distribution of the negative electrode measured by the mercury intrusion method is typically between 0.01μ, and 0.2 μm inclusive, and preferably between 0.02 μm and 0.1 μm inclusive. The volume of the pores, of which the diameter measured by the mercury intrusion method is between 0.01 μm and 0.2 μm inclusive, is typically between 0.05 mL and 0.5 mL inclusive, and preferably between 0.1 mL and 0.3 mL inclusive, per 1 g of the negative electrode (with the weight of the negative electrode current collector excluded). The part of weight that has no relation to the diameter distribution is eliminated by subtracting the weight of the negative electrode current collector from the weight of the negative electrode. The surface area of the pores, of which the diameter measured by the mercury intrusion method is between 0.01 μm and 0.2 μm inclusive, is preferably between 5 m² and 50 m² inclusive, and more preferably between 7 m² and 30 m² inclusive.

The mode diameter of the second peak of the diameter distribution of the negative electrode measured by the mercury intrusion method is typically between 0.003 μm and 0.02 μm inclusive, and preferably between 0.005 μm and 0.015 μm inclusive. The volume of the pores, of which the diameter measured by the mercury intrusion method is between 0.003 μm and 0.02 μm inclusive, is typically between 0.0001 mL and 0.02 mL inclusive, and preferably between 0.0005 mL and 0.01 mL inclusive, per 1 g of the negative electrode (with the weight of the negative electrode current collector excluded). The surface area of the pores, of which the diameter measured by the mercury intrusion method is between 0.003 μm and 0.02 μm inclusive, is preferably between 0.1 m² and 101 m² inclusive, and more preferably between 0.2 m² and 2 m² inclusive, per 1 g of the negative electrode (with the weight of the negative electrode current collector excluded).

The volume of the pores of the negative electrode measured by the mercury intrusion method is preferably between 0.1 mL and 1 mL inclusive, and more preferably between 0.2 mL and 0.5 mL inclusive, per 1 g of the negative electrode (with the weight of the negative electrode current collector excluded). The surface area of the pores of the negative electrode measured by the mercury intrusion method is preferably between 5 m² and 50 m² inclusive, and more preferably between 7 m² and 30 m² inclusive, per 1 g of the negative electrode (with the weight of the negative electrode current collector excluded).

The nonaqueous electrolyte solution used in the liquid electrolyte layer typically contains a sultone having an unsaturated hydrocarbon radical. When a sultone having an unsaturated hydrocarbon radical is added, a thin and tight film and a thick film are selectively formed on the surface of the negative electrode active material and the surface of the negative-electrode electrically conducting material, respectively, so that it is possible to effectively suppress the generation of gas from the negative electrode during storage under high-temperature conditions without impairing the performance of high current operation and the cycle characteristics. In addition, the film formed thin and tight on the surface of the negative electrode active material has an effect of suppressing the self discharge during storage.

Specific examples of the sultone having an unsaturated hydrocarbon radical include ethylene sultone, 1,3-propene sultone, 1,4-butane sultone, 1,5-pentene sultone, 1-methyl-1,3-propene sultone, 1-fluoro-1,3-propene sultone, 2-methyl-1,3-propene sultone, 3-methyl-1,3-propene sultone, and 1-trifluoromethyl-1,3-propene sultone. Among others, 1,3-propene sultone and 1,4-butene sultone are preferable. The content of sultone having an unsaturated hydrocarbon radical is preferably between 0.001 percent by weight and 10 percent by weight inclusive, and more preferably between 0.01 percent by weight and 2 percent by weight inclusive, relative to the total weight of the nonaqueous electrolyte solution.

The nonaqueous electrolyte solution may contain a sultone having a saturated hydrocarbon radical in addition to the sultone having an unsaturated hydrocarbon radical. Examples of the sultone having a saturated hydrocarbon radical include 1,3-propane sultone, 1,4-butane sultone, 1,5-pentane sultone, 1,6-hexane sultone, 1-methyl-1,3-propane sultone, 2-methyl-1,3-propane sultone, 3-methyl-1,3-propane sultone, 1-methyl-1,4-butane sultone, 2-methyl-1,4-butane sultone, 3-methyl-1,4-butane sultone, and 4-methyl-1,4-butane sultone. Among others, 1,3-propane sultone and 1,4-butane sultone are preferable. The content of sultone having a saturated hydrocarbon radical is preferably between 0.001 percent by weight and 10 percent by weight inclusive, and more preferably between 0.01 percent by weight and 2 percent by weight inclusive, relative to the total weight of the nonaqueous electrolyte solution. It is preferable that the nonaqueous electrolyte solution contain at least two nonaqueous solvents selected from the group consisting of propylene carbonate, ethylene carbonate, and γ-butyrolactone. Description concerning the lithium salt is similar to that given above.

It is preferable that the lithium-ion battery of the invention have a separator between the positive electrode active material layer and the negative electrode active material layer. This is because a highly safe battery is obtained. In addition, in this case, the diameter distribution in the separator affects the high current operation of the Lithium-ion battery. In the invention, it is preferable that the median diameter be greater than the mode diameter when the diameter distribution in the separator is measured. The median diameter of the pores in the separator measured by the mercury intrusion method is preferably between 0.15 μm and 1 μm inclusive, and more preferably between 0.18 μm and 0.40 μm inclusive. The mode diameter of the pores in the separator measured by the mercury intrusion method is preferably between 0.12 μm and 0.5 μm inclusive, and between 0.18 μm and 035 μm inclusive. The porosity of the separator is preferably between 45% and 75% inclusive, and more preferably between 50% and 60% inclusive.

The invention is not limited to the above embodiments. The above embodiments are merely examples and those substantially the same as the technical idea recited in the claims and bringing about similar operations and effects are all within the scope of the invention.

Examples will be given below and the invention will be more specifically described.

### Example 1

First, Li₄Ti₅O₁₂ (made by ISHTHARA SANGYO KAMA, LTD, and hereinafter referred to as LTO), of which the average particle size was 10 μm, was prepared as a raw material compound, and urea (made by Sigma-Aldrich Co.) was prepared as the nitriding agent. Next, 1 g of LTO and 1 g of urea were measured (LTO:urea=10:40 in molar ratio) and mixed in a mortar to obtain a raw material composite. Then, the obtained raw material composite was formed into a mold with the dimensions, φ 1 cm×2 mm thick, in a molding machine, and the obtained mold was put in a glass tube and the inside of the glass tube was made vacuum. Next, the glass tube was fired at 500° C. in a tubular furnace for three hours. Thus, the nitrided Li—Ti compound oxide was synthesized. Then, the mold was fired in the air atmosphere at 500° C. for an hour to remove the remaining urea, whereby a nitrided Li—Ti compound oxide was obtained. The specific surface area of the obtained nitrided Li—Ti compound oxide was measured by the BET method. In the measurement, a full-automatic gas adsorption measuring apparatus (Autosore®-1 made by Yuasa Ionics Inc.) for measuring specific surface area and pore distribution was used. As a result, the specific surface area of the nitrided Li—Ti compound oxide was 0.5 m²/g.

### Comparative Example 1

The LTO used in Example 1 was used as a reference compound.

### Example 2-1

A nitrided Li—Ti compound oxide was obtained in a manner similar to Example 1, except that the firing conditions of 500° C. and three hours were changed to the firing conditions of 200° C. and six hours.

### Examples 2-2 to 2-5

A nitrided Li—Ti compound oxide was obtained in a manner similar to Example 2-1, except that the firing temperature of 200° C. was changed to 300° C., 400° C., 500° C., and 600° C., respectively.

### Comparative Example 2

An experiment was conducted referring to JP-A-2006-32321 cited above. First, TiO₂ (made by Wako Pure Chemical Industries, Ltd.) was prepared as a raw material compound. Next, 30 g of TiO₂ was put into a tubular furnace (φ 10 cm×100 cm), and the inside of the furnace was replaced by N₂ by flowing N₂ gas for two hours. Then, TiO₂ was heated at 800° C. for six hours while flowing N₂ gas (flow rate: 3 L/min). Then, TiO₂ was heated at 800° C. for six hours while flowing N₂ gas (flow rate: 1 L/min) and NH₃ gas (flow rate: 1 L/min), whereby a nitrided TiO₂ was obtained.

### (Evaluation)

### (1) Measurement of Oxidation-Reduction Potential by Cyclic Voltammetry (CV)

The nitrided Li—Ti compound oxide obtained in Example 1 and the reference compound obtained in Comparative Example 1 were used to measure the oxidation-reduction potential. First, button batteries to be evaluated were made. Active material layers were formed, each having the nitrided Li—Ti compound oxide or the reference compound, which is an active material, polytetrafluoroethylene (PTFE), which is a binder, and Ketjen Black (KB), which is an electrically conducting material, at a ratio of (active material):(binder):(electrically conducting material)=75:5:25 (weight ratio). Next, Li was used as an opposite pole layer and a solution, in which LiPF₆ was dissolved at a concentration of 1 M in a nonaqueous solvent obtained by mixing ethylene carbonate (EC) and dimethyl carbonate (DEC) at a volume ratio of 1:1, was used as the nonaqueous solution, to obtain button batteries to be evaluated.

The obtained button batteries to be evaluated were subjected to cyclic voltammetry (CV) with the use of an electrochemical measurement system (Model 147055BEC made by Solartron Analytical), whereby the oxidation-reduction potential was measured. The measurement conditions were that the potential range was 2.0 V to 4.2 V (vs Li/Li⁺) and that the sweep speed was 0.1 mV/sec. The obtained results of the oxidation-reduction potential are shown in Table 1.

TABLE 1

| | Reduction Potential (V) | Oxidation Potential (V) |
|---|---|---|
| Example | 1.70 | 1.45 |
| Comparative | 1.79 | 1.46 |
| Example | | |

As shown in Table 1, it has been confirmed that in the case of Example 1, the oxidation potential does not change and the reduction potential is reduced by approximately 0.1 V as compared to those of Comparative Example 1. When LTO is used as the negative electrode active material, the difference between the oxidation potential of the positive electrode active material and the reduction potential of LTO becomes the battery voltage. Specifically, the lower the reduction potential is, the higher the battery voltage is. It has been confirmed that in the case of Example 1, the battery voltage increases by approximately 0.1 V. On the other hand, the difference between the reduction potential of the positive electrode active material and the oxidation potential of LTO is the voltage for charging the battery and the oxidation potential of LTO is at the same level between Example 1 and Comparative Example 1. In this way, an advantageous result has been obtained also in terms of the voltage for charging the battery.

### (2) X-ray Photoelectron Spectroscopy

The nitrided Li—Ti compound oxides obtained in Examples 2-1 to 2-5 were subjected to X-ray photoelectron spectroscopy (XPS). In the XPS, measurement was conducted for the N is spectrum. The results are shown in FIG. 3. The state of N in the nitrided Li—Ti compound oxide can be qualitatively and quantitatively evaluated by the XPS measurement for the N is spectrum. When the result is analyzed qualitatively, the peak on the higher energy side is the peak (402 eV to 399 eV) indicating the component adsorbed on the surface and the organic component. Thus, the shift of the peak to the lower energy side indicates that 0 in Li₄Ti₅O₁₂ is replaced by N (specifically, the peak from 399 eV to 396 eV). On the other hand, when the result is analyzed quantitatively, the higher the peak intensity is, the greater the amount of 0 in Li₄Ti₅O₁₂ that has been replaced by N is. When FIG. 3 is studied with this taken into consideration, the peaks are shifted to the lower energy side as the firing temperature increases in the cases of Examples 2-1 to 2-5 and it has therefore been confirmed that nitriding had progressed. Note that although nitriding had sufficiently progressed in the case of Example 2-5, the peak intensity is slightly low, which has indicated the possibility that nitrogen atoms were eliminated a little from the nitrided Li—Ti compound oxide.

### (3) Evaluation of Nitriding Method Used in Comparative Example 2

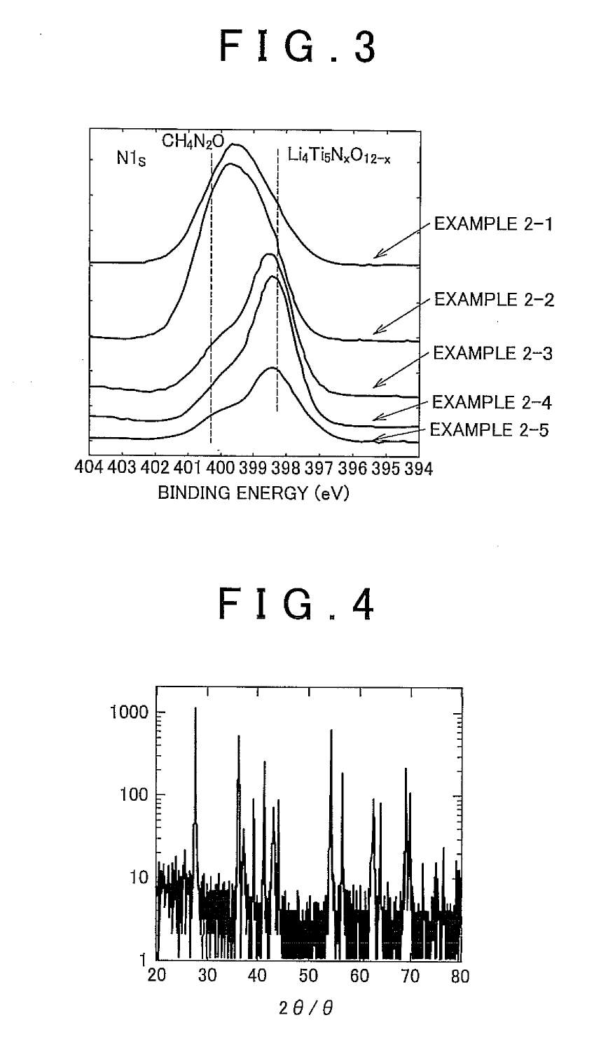

X-ray diffraction measurements were conducted with the use of nitrided obtained in Comparative Example 2. The result is shown in FIG. 4. There is no significant difference between the peaks in XRD shown in FIG. 4 and those of TiO₂ before nitriding and it has therefore been confirmed that the obtained nitrided TiO₂ has a crystal structure similar to that of TiO₂ before nitriding. Meanwhile, a button battery to be evaluated was made with the use of the nitrided TiO₂ obtained in Comparative Example 2 and charging and discharging were conducted. The charging and discharging conditions were as follows:

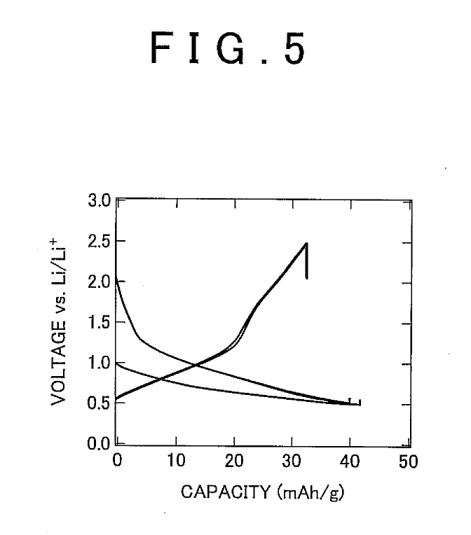

Constant current charging and discharging: 0.2 mA;
Charging and discharging range: 0.5 V to 3.0 V; and
Initial operation: Discharge.
The result is shown in FIG. 5. As shown in FIG. 5, nitrided TiO₂ obtained in Comparative Example 2 does not show the charging and discharging characteristics described in JP-A-2006-32321.

The invention has been described with reference to example embodiments for illustrative purposes only. It should be understood that the description is not intended to be exhaustive or to limit form of the invention and that the invention may be adapted for use in other systems and applications. The scope of the invention embraces various modifications and equivalent arrangements that may be conceived by one skilled in the art.

In the first aspect, the raw material is preferably a Li—Ti compound oxide. This is because when the raw material compound (Li—Ti compound oxide) is used rather than a raw material mixture, the nitrided Li—Ti compound oxide is easily obtained.

In the first aspect, the Li—Ti compound oxide is preferably a compound that is expressed by LiₐTi_{b}O_{c} (0<a≦5, 3≦b≦7, 10≦c≦14). This is because the nitrided Li—Ti compound oxide that is lower in reduction potential is obtained.

In the first aspect, the raw material is preferably Li₄Ti₅O₁₂. This is because the nitrided Li—Ti compound oxide that is further lower in reduction potential is obtained.

In the first aspect, the nitriding agent is preferably urea. This is because nitriding is effectively performed.

In the first aspect, a firing temperature in the synthesizing is preferably within a range of 100° C. to 800° C. This is because the nitrided Li—Ti compound oxide that is lower in reduction potential is obtained.

In the first aspect, the firing temperature in the synthesizing is preferably within a range of 300° C. to 600° C. This is because the nitrided Li—Ti compound oxide is obtained, in which nitriding has sufficiently progressed and at the same time, the elimination of nitrogen from the nitrided Li—Ti compound oxide is suppressed.

In the first aspect, a firing time in the synthesizing is preferably within a range of 10 minutes to 7 hours. This is because the nitrided Li—Ti compound oxide that is lower in reduction potential is obtained.

In the second aspect, the nitrided Li—Ti compound oxide is preferably a compound that is expressed by LiₐTi_{b}O_{c}N_{d}(0<a≦5, 3≦b≦7, 11≦c≦14, 0.01≦d≦1). In addition, in the second aspect, it is preferable that nitrogen be present in the inside of the nitrided Li—Ti compound oxide.

In the third aspect, it is preferable that the nitrogen be present in the inside of the nitrided Li—Ti compound oxide.

In the fourth aspect, it is preferable that the nitrided Li—Ti compound oxide be particulate. This is because the particulate Li—Ti compound oxide does not suffer the occurrence of a detachment, a crack, etc. unlike a film and is therefore excellent in durability.

In the fourth aspect, an average particle size of the nitrided Li—Ti compound oxide is preferably within a range of 100 nm to 100 μm. This is because such a nitrided Li—Ti compound oxide is useful as a negative electrode active material, for example.

In the fourth aspect, a specific surface area of the nitrided Li—Ti compound oxide is preferably within a range of 0.1 m²/g to 300 m²/g.

In the fourth aspect, it is preferable that the nitrided Li—Ti compound oxide be used as a negative electrode active material. This is because such a nitrided Li—Ti compound oxide is low in reduction potential and it is therefore possible to increase the battery voltage.

In the fourth aspect, it is preferable that the nitrified Li—Ti compound oxide be obtained by the method described above.

In the fifth aspect, the electrolyte layer is preferably a liquid electrolyte layer or a solid electrolyte layer. When the electrolyte layer is the liquid electrolyte layer, a high-power lithium-ion battery is obtained. When the electrolyte layer is the solid electrolyte layer, a lithium-ion battery that is excellent in safety is obtained.

What is claimed is:

1. A method of producing a nitrided Li—Ti compound oxide, comprising:
preparing a raw material composite that has a raw material containing lithium, titanium, and oxygen and a nitriding agent that is expressed by a following General Formula (1) and is solid or liquid at room temperature (25° C.); and
synthesizing the nitrided Li—Ti compound oxide by firing the raw material composite to nitride the raw material, 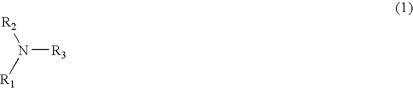
wherein R₁, R₂, and R₃ are independent of each other and are each a functional group having at least one of carbon (C), hydrogen (H), oxygen (O), and nitrogen (N).

2. The method according to claim 1, wherein the raw material is a Li—Ti compound oxide.

3. The method according to claim 2, wherein the Li—Ti compound oxide is a compound that is expressed by LiₐTi_{b}O_{c}, (0<a≦5, 3≦b≦7, 10≦c≦14).

4. The method according to claim 3, wherein the raw material is Li₄Ti₅O₁₂.

5. The method according to claim 1, wherein the nitriding agent is urea.

6. The method according to claim 1, wherein a firing temperature in the synthesizing is within a range of 100° C. to 800° C.

7. The method according to claim 6, wherein the firing temperature in the synthesizing is within a range of 300° C. to 600° C.

8. The method according to claim 1, wherein a firing time in the synthesizing is within a range of 10 minutes to 7 hours.

9. A nitrided Li—Ti compound oxide comprising lithium, titanium, oxygen, and nitrogen, wherein the nitrided Li—Ti compound oxide is crystalline.

10. The nitrided Li—Ti compound oxide according to claim 9, wherein the nitrided Li—Ti compound oxide is a compound that is expressed by LiₐTi_{b}O_{c}N_{d} (0<a≦5, 3≦b≦7, 11≦c≦14, 0.01≦d≦1).

11. The nitrided Li—Ti compound oxide according to claim 9, wherein nitrogen is present in an inside of the nitrided Li—Ti compound oxide.

12. A nitrided Li—Ti compound oxide comprising lithium, titanium, oxygen, and nitrogen, wherein the nitrided Li—Ti compound oxide is expressed by LiₐTi_{b}O_{c}N_{d} (0<a≦5, 3≦b≦7, 11≦c≦14, 0.01≦d≦1).

13. The nitrided Li—Ti compound oxide according to claim 12, wherein the nitrogen is present in an inside of the nitrided Li—Ti compound oxide.

14. A nitrided Li—Ti compound oxide comprising lithium, titanium, oxygen, and nitrogen, wherein the nitrogen is present in an inside of the nitrided Li—Ti compound oxide.

15. The nitrided Li—Ti compound oxide according to claim 9, wherein the nitrided Li—Ti compound oxide is particulate.

16. The nitrided Li—Ti compound oxide according to claim 15, wherein an average particle size is within a range of 100 nm to 100 μm.

17. The nitrided Li—Ti compound oxide according to claim 15, wherein a specific surface area is within a range of 0.1 m²/g to 300 m²/g

18. The nitrided Li—Ti compound oxide according to claim 9, wherein the nitrided Li—Ti compound oxide is used as a negative electrode active material.

19. The nitrided Li—Ti compound oxide according to claim 9, wherein the nitrided Li—Ti compound oxide is obtained by the method according to claim 1.

20. A lithium-ion battery comprising:
a positive electrode active material layer containing a positive electrode active material;
a negative electrode active material layer containing a negative electrode active material; and
an electrolyte layer formed between the positive electrode active material layer and the negative electrode active material layer,
wherein the negative electrode active material is the nitrided Li—Ti compound oxide according to claim 9.

21. The lithium-ion battery according to claim 20, wherein the electrolyte layer is a liquid electrolyte layer or a solid electrolyte layer.
